(19) United States
(12) Patent Application Publication
(10) Pub. No.: US 2026/0079928 A1
(43) Pub. Date: Mar. 19, 2026

(54) INFORMATION PRESENTATION METHOD BASED ON LARGE MODEL, DEVICE, AND MEDIUM

(71) Applicant: BEIJING BAIDU NETCOM SCIENCE TECHNOLOGY CO., LTD., Beijing (CN)

(72) Inventors: Jingjia CAO, Beijing (CN); Jingfeng DENG, Beijing (CN); Jingbo ZHOU, Beijing (CN)

(21) Appl. No.: 19/402,461

(22) Filed: Nov. 26, 2025

(30) Foreign Application Priority Data
Jun. 17, 2025 (CN) 202510811862.0

(51) Int. Cl. G06F 16/242; G06F 16/248

(52) U.S. Cl. CPC G06F 16/243; G06F 16/248

(57) ABSTRACT

An information presentation method based on a large model, a device, and a medium, which relate to the field of data processing technologies, and in particular to the field of artificial intelligence technologies such as large models, natural language processing, and deep learning. The method includes: matching, in response to receiving a query question, the query question against a set of target example pairs corresponding to a query type of the query question to obtain at least one reference example pair, where the large model is configured to generate a query statement for the query question using the reference example pair; invoking the large model according to a prompt information to generate a target query statement, where the prompt information is obtained based on the query question and the at least one reference example pair; and presenting a query result obtained by executing the target query statement.

This application claims the benefit of priority to Chinese Patent Application No. 202510811862.0, filed on Jun. 17, 2025. The entire contents of this application are hereby incorporated herein by reference.

### TECHNICAL FIELD

The present disclosure relates to the field of data processing technologies, in particular to the field of artificial intelligence technologies such as large models, natural language processing, and deep learning, and more specifically, to an information presentation method based on a large model, a device, and a medium.

### BACKGROUND

With the advent of the era of big data, the demand for data query and analysis is increasing. As data query methods based on structured query statements require a high level of professional knowledge from users, data query methods based on natural language have emerged in order to lower the threshold of data query technology. A data query method based on natural language allows users to raise query questions in natural language and automatically converts the query questions into query statements to achieve data query and analysis.

### SUMMARY

The present disclosure provides an information presentation method based on a large model, a device, and a medium.

According to an aspect of the present disclosure, an information presentation method based on a large model is provided, including: matching, in response to receiving a query question, the query question against a set of target example pairs corresponding to a query type of the query question to obtain at least one reference example pair, where the large model is configured to generate a query statement for the query question using the reference example pair; invoking the large model according to a prompt information to generate a target query statement, where the prompt information is obtained based on the query question and the at least one reference example pair; and presenting a query result obtained by executing the target query statement.

According to another aspect of the present disclosure, an artificial intelligence agent is provided, which is configured to perform steps in the method described above.

According to another aspect of the present disclosure, an electronic device is provided, including: one or more processors; and a memory configured to store one or more computer programs, where the one or more processors are configured to execute the one or more computer programs to perform steps in the method described above.

According to another aspect of the present disclosure, a non-transitory computer-readable storage medium having computer programs or instructions therein is provided, where the computer programs or instructions, when executed by a processor, are configured to implement steps in the method described above.

It should be understood that the content described in this section is not intended to identify key or essential features of embodiments of the present disclosure, nor is it intended to limit the scope of the present disclosure. Other features of the present disclosure will become easily understood through the following description.

### BRIEF DESCRIPTION OF THE DRAWINGS

Through the following description of embodiments of the present disclosure with reference to the accompanying drawings, the above and other objectives, features, and advantages of the present disclosure will become more clear. In the accompanying drawings:

FIG. 1 schematically shows a system architecture to which an information presentation method based on a large model may be applied according to an embodiment of the present disclosure;

FIG. 2 schematically shows a flowchart of an information presentation method based on a large model according to an embodiment of the present disclosure;

FIG. 3A schematically shows a schematic diagram of an example process for constructing a set of candidate example pairs according to an embodiment of the present disclosure;

FIG. 3B schematically shows a schematic diagram of an example process for constructing a set of target example pairs according to an embodiment of the present disclosure;

FIG. 4A schematically shows a schematic diagram of an example process for determining a set of candidate example pairs according to another embodiment of the present disclosure;

FIG. 4B schematically shows a schematic diagram of an example process for determining a set of target example pairs according to another embodiment of the present disclosure;

FIG. 5 schematically shows a schematic diagram of an example process for determining a reference example pair according to an embodiment of the present disclosure;

FIG. 6 schematically shows a block diagram of an information presentation apparatus based on a large model according to an embodiment of the present disclosure;

FIG. 7 schematically shows a structural block diagram of an agent of a large model according to an embodiment of the present disclosure; and

FIG. 8 schematically shows a block diagram of an electronic device suitable for implementing an information presentation method based on a large model according to an embodiment of the present disclosure.

### DETAILED DESCRIPTION OF EMBODIMENTS

Embodiments of the present disclosure will now be described with reference to the accompanying drawings. It should be understood that these descriptions are merely exemplary and are not intended to limit the scope of the present disclosure. In the following detailed description, numerous specific details are set forth in order to provide a thorough understanding of embodiments of the present disclosure. However, it is evident that one or more embodiments may be implemented without these specific details. In addition, well-known structures and technologies are omitted in the following description to avoid unnecessarily obscuring the concepts of the present disclosure.

The terminology used herein is for the purpose of describing particular embodiments only and is not intended to limit the present disclosure. As used herein, the terms “include”, “including” and the like indicate the presence of stated features, steps, operations, and/or components but do not preclude the presence or addition of one or more other features, steps, operations, or components.

All terms (including technical and scientific terms) used herein have the meanings commonly understood by those skilled in the art, unless otherwise defined. It should be noted that the terminology used herein should be interpreted in a manner consistent with the context of this specification and should not be construed in an idealized or overly formal sense.

Where expressions such as “at least one of A, B, or C” are used, they should generally be interpreted according to the common understanding of those skilled in the art (for example, “a system having at least one of A, B, or C” may include, but is not limited to, a system having only A, only B, only C, both A and B, both A and C, both B and C, and/or A, B, and C together).

Data query methods based on natural language require providing high-quality examples for a large model to help the large model understand tasks and accurately generate query statements.

In some examples, it is also possible not to use any examples, or to use a fixed example set, or to rely on manual selection of examples. However, manually selecting appropriate examples for each query question is time-consuming and non-scalable, and a fixed example set cannot provide optimal support for different types of queries. Therefore, these methods are difficult to ensure efficiency and accuracy of data query and analysis.

In view of the above, embodiments of the present disclosure provide an information presentation method based on a large model. For example, in response to receiving a query question, the query question is matched against a set of target example pairs corresponding to a query type of the query question, to obtain at least one reference example pair, where the reference example pair is used to guide the large model to generate a query statement for the query question. The large model is invoked according to a prompt information to generate a target query statement, where the prompt information is obtained based on the query question and the at least one reference example pair. And, a query result obtained by executing the target query statement is presented.

According to embodiments of the present disclosure, by determining reference example pairs from an example library according to the query type of the query question, it is possible to automatically and intelligently select the most relevant examples for each query question, thereby improving the accuracy and scalability of data query. On this basis, by using the reference example pairs to guide the large model to generate query statements, the workload and error rate of manual selection of examples are reduced. This enables the method to adapt to query requirements of different types and different degrees of complexity, and to quickly and accurately respond to users' query questions in natural language, thereby providing users with personalized and intelligent data query services and effectively improving the accuracy and efficiency in generating query statements and obtaining query results.

In technical solutions of the present disclosure, the collection, storage, use, processing, transmission, provision, disclosure and other processing of user personal information involved comply with provisions of relevant laws and regulations and do not violate public order and good custom.

In the technical solutions of the present disclosure, the acquisition or collection of user personal information has been authorized or allowed by users.

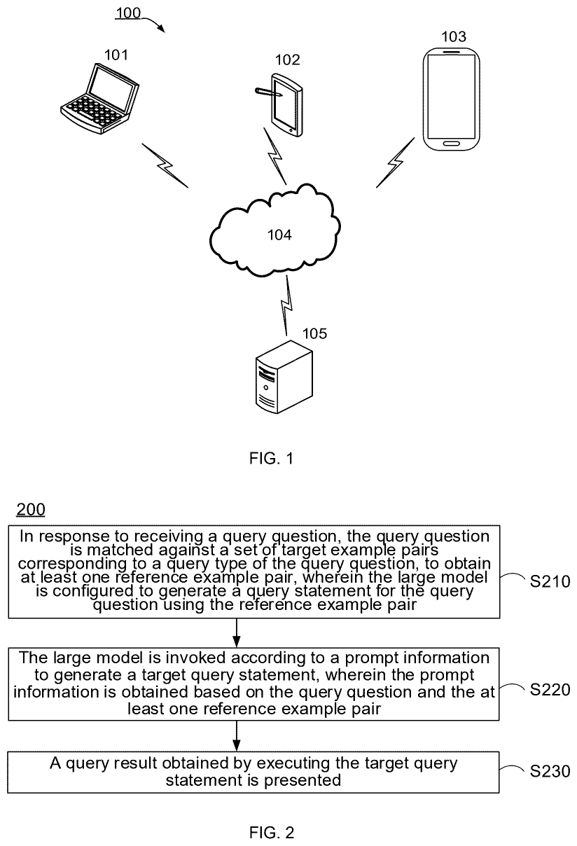

FIG. 1 schematically shows a system architecture to which an information presentation method based on a large model may be applied according to an embodiment of the present disclosure. It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios.

As shown in FIG. 1, a system architecture 100 according to this embodiment may include a first terminal device 101, a second terminal device 102, a third terminal device 103, a network 104, and a server 105. The network 104 serves as a medium for providing a communication link between the first terminal device 101, the second terminal device 102, the third terminal device 103 and the server 105. The network 104 may include various types of connection, such as wired and/or wireless communication links, or optical fiber cables.

The first terminal device 101, the second terminal device 102, and the third terminal device 103 may be used by a user to interact with the server 105 through the network 104 to receive or send messages, etc. The first terminal device 101, the second terminal device 102, and the third terminal device 103 may be installed with various communication client applications, such as shopping applications, web browser applications, search applications, instant messaging tools, email clients, and/or social platform software, etc. (only for example).

The first terminal device 101, the second terminal device 102, and the third terminal device 103 may be various electronic devices having display screens and supporting web browsing, including but not limited to smart phones, tablet computers, laptop computers, and desktop computers, etc.

The server 105 may be a server providing various services, such as a background management server (only for example) that provides a support for content browsed by the user using the first terminal device 101, the second terminal device 102, and the third terminal device 103. The background management server may analyze and process received data such as a user request, and return a processing result (such as a web page, information, or data acquired or generated according to the user request) to the terminal devices.

It should be noted that the information presentation method based on a large model provided in embodiments of the present disclosure may generally be performed by the server 105. Accordingly, the information presentation apparatus based on a large model provided in embodiments of the present disclosure may be generally arranged in the server 105. The information presentation method based on a large model provided in embodiments of the present disclosure may also be performed by a server or server cluster different from the server 105 and capable of communicating with the first terminal device 101, the second terminal device 102, the third terminal device 103, and/or the server 105. Accordingly, the information presentation apparatus based on a large model provided in embodiments of the present disclosure may also be arranged in a server or server cluster different from the server 105 and capable of communicating with the first terminal device 101, the second terminal device 102, the third terminal device 103, and/or the server 105.

Alternatively, the information presentation method based on a large model provided in embodiments of the present disclosure may be performed by the first terminal device 101, the second terminal device 102, or the third terminal device 103, or by other terminal devices different from the first terminal device 101, the second terminal device 102, or the third terminal device 103. Accordingly, the information presentation apparatus based on a large model provided in embodiments of the present disclosure may be arranged in the first terminal device 101, the second terminal device 102, or the third terminal device 103, or in other terminal devices different from the first terminal device 101, the second terminal device 102, or the third terminal device 103.

It should be understood that the numbers of terminal devices, networks and servers shown in FIG. 1 are merely schematic. According to implementation needs, any number of terminal devices, networks and servers may be provided.

It should be noted that sequence numbers of operations in the following methods are merely used to represent the operations for ease of description, and should not be regarded as indicating an execution order of the operations. Unless explicitly stated, the method does not need to be performed exactly in the order shown.

The system architecture to which the information presentation method based on a large model may be applied provided by the present disclosure has been described above. The information presentation process based on a large model according to the present disclosure will be further described with reference to FIG. 2 as an example.

FIG. 2 schematically shows a flowchart of an information presentation method based on a large model according to an embodiment of the present disclosure.

As shown in FIG. 2, the information presentation method 200 based on a large model includes operation S210 to operation S230.

In operation S210, in response to receiving a query question, the query question is matched against a set of target example pairs corresponding to a query type of the query question, to obtain at least one reference example pair, where the reference example pair is used to guide the large model to generate a query statement for the query question.

In operation S220, the large model is invoked according to a prompt information to generate a target query statement, and the prompt information is obtained based on the query question and the at least one reference example pair.

In operation S230, a query result obtained by executing the target query statement is presented.

Before performing the information presentation method provided by the present disclosure, a plurality of historical query questions and a plurality of historical query statements respectively corresponding to the plurality of historical query questions may be acquired. Semantic embedding may be performed on the historical query questions by using a semantic embedding model, thereby obtaining semantic features for the historical query questions. For each historical query question, the semantic feature corresponding to that historical query question and the historical query statement corresponding to that historical query question may be combined to form an example pair. On this basis, each historical query question may be classified to obtain a query type of the historical query question, and the query type may be associated with the corresponding example pair. By collecting a plurality of example pairs corresponding to various query types, a set of candidate example pairs may be constructed, which facilitates subsequent label-based retrieval and diversity-based filtering.

In embodiments of the present disclosure, user consent or authorization may be obtained prior to acquiring user information. For example, prior to operation S210, a request to acquire user information may be sent to the user. Operation S210 is performed upon obtaining user consent or authorization to acquire the user information.

The query question refers to a question raised by a user in a natural language form to express requirements for data to be retrieved. For example, the query question may be “In which month did Company A achieve the highest total profit in year X?”. After the query question is received, the query question may be classified to obtain a query type. The specific classification method may be configured according to actual service requirements and is not limited herein. For example, the query type may be obtained by performing an intent analysis on the query question. Alternatively, a hierarchical classification label system may be predefined, and the query question may be classified based on the classification label system to obtain the query type.

After the query type is obtained, a set of target example pairs corresponding to the query type may be determined from a pre-constructed set of candidate example pairs according to the query type. The set of target example pairs refers to a set of example pairs corresponding to the query type, which are selected from a pre-constructed example library. The set of target example pairs may include a plurality of candidate example pairs. For these candidate example pairs, the query question may be matched against the candidate example pairs to determine a reference example pair from the plurality of candidate example pairs.

The reference example pair refers to an example pair related to the query question, which is used to guide the large model to generate a query statement for the query question, that is, to help the large model better understand the task and accurately generate a target query statement. The method for determining the reference example pair may be configured according to actual service requirements and is not limited herein. For example, the query question may be converted into a semantic feature to be matched by using a semantic embedding model, and the semantic feature to be matched may be compared with a candidate semantic feature in each candidate example pair to determine a similarity, thereby obtaining the reference example pair. Alternatively, a word segmentation may be performed on the query question to obtain keywords to be matched, and the keywords to be matched may be compared with keywords of a candidate query question in each candidate example pair to determine a similarity, thereby obtaining the reference example pair.

After at least one reference example pair is obtained, a prompt information may be constructed based on the query question and the reference example pair. The prompt information is used as input to the large model to assist in generating a target query statement. The prompt information may include the query question, the semantic feature of a reference query question in each reference example pair, and a reference query statement in each reference example pair, which may provide context and reference for the large model, enabling the large model to more accurately generate a target query statement that meets user requirements. The target query statement may accurately express users' data query requirements and may be executed in a database to obtain data required by users, and the query result may then be obtained and presented.

The method for generating the target query statement may be configured according to actual service requirements and is not limited herein. For example, an enhanced prompt may be constructed by combining the selected reference example pair with the query question and a data table structure corresponding to the query question, and the enhanced prompt may be input to the large model to generate a target query statement for the query question. Alternatively, a corresponding template may be designed according to the reference query statement and the semantic information of the reference query question in the reference example pair, and specific elements in the query question may be filled into the template to form a prompt information, which is then input into the large model to generate a target query statement.

The query result may be presented to the user in a user-friendly manner. For example, an appropriate chart type (such as a bar chart, line chart, pie chart, etc.) may be selected according to the type and characteristics of the query result, so as to intuitively present the data and assist the user in more clearly understanding and analyzing the data. In addition, while presenting the query result, at least one reference example pair may also be presented to enhance interpretability.

After the query statement is obtained, the query statement may be executed and the query result may be presented. The presentation form of the query result may be configured according to actual service requirements and is not limited herein. For example, the presentation form of the query result may include at least one of a table form, a chart form, or a text form. The table form may be used to present a structured query result. The chart form may include bar charts, line charts, pie charts, and scatter plots. A bar chart is used to present comparisons of data between different categories. A line chart is used to present a trend of data changing over time. A pie chart is used to present a proportion of parts relative to the whole. A scatter plot is used to present a relationship between two variables. The text form is used to provide a summarized description of the query result.

According to embodiments of the present disclosure, by selecting reference example pairs from an example library according to the query type of the query question, it is possible to automatically and intelligently select the most relevant examples for each query question, thereby improving the accuracy and scalability of data query. On this basis, by using the reference example pairs to guide the large model to generate query statements, the workload and error rate of manual selection of examples are reduced. This enables the method to adapt to query requirements of different types and different degrees of complexity, and to quickly and accurately respond to users' query questions in natural language, thereby providing users with personalized and intelligent data query services and effectively improving the accuracy and efficiency in generating query statements and obtaining query results.

In an embodiment, operation S210 may include the following operations: classifying the query question according to a preset classification rule to obtain a query type, where the preset classification rule defines at least one of a keyword corresponding to the query type, semantics corresponding to the query type, or an expression form corresponding to the query type; determining a set of target example pairs from the set of candidate example pairs according to the query type; and matching the query question against the set of target example pairs to obtain at least one reference example pair.

After the query question is received, the query question may be classified according to the preset classification rule to obtain the query type. The preset classification rule refers to predefined standards and criteria for classifying query questions, in which at least one of the keywords, semantics, or expression forms corresponding to various query types is defined.

Keywords refer to words in the query question that may reflect a core query intent and content, which may be used to quickly and preliminarily determine a possible type to which the query question belongs. For example, words such as “sum” and “average” are typically related to queries of a statistical report type, while words such as “growth” and “downward trend” are typically related to queries of a trend analysis type. Accordingly, a preset classification rule based on keywords may specify that a query question containing keywords such as “sorting”, “top”, or “highest” belongs to a ranking list query type.

Semantics refers to the inherent meaning and logical relationship expressed by the query question. By understanding the semantics of the query question, the corresponding query type may be determined more accurately. For example, in terms of semantics, the query question “What is the growth rate of GDP of each province in 2023 compared with the previous year?” involves data comparison and calculation over a time series, and belongs to a trend-analysis query type. Based on this, a preset classification rule based on semantics may specify that a query question having semantics of comparison and contrast belongs to a comparative-analysis query type.

Expression forms refer to the method and structure in which the query question is presented, including the sentence pattern, temporal modifiers, locative modifiers, and other expression elements used for questioning. For example, “Please list the monthly sales for 2023” is a query question expressed for a list form, focusing on data representation; whereas “Please analyze the trend of the company's profit over the past five years” is a query question expressed for a trend analysis form. Based on this, a preset classification rule based on expression forms may specify that a query question presented in expression forms such as time series and trends belongs to a trend analysis query type.

By way of example, if the received query question is “In which month did Company A achieve the highest total profit in year B?”, it may be identified, according to the preset classification rule based on keywords, that the query question includes the word “highest”, thus it may be determined that the query question belongs to a ranking list query type. In addition, according to the preset classification rule based on semantics, it may be identified that the query question exhibits comparative semantics, thus it may be determined that the query question belongs to a comparative analysis query type.

In an example, in addition to the classification method based on the preset classification rules described above, a text classification algorithm based on machine learning may also be adopted, which may include Support Vector Machine (SVM), Naive Bayes, or the like. For example, a large number of sample query questions may be labeled and classified, then text features may be extracted from the sample query questions, and a classification model may then be trained. When a new query question is input and received, the trained classification model may be used to classify the new query question to obtain a query type.

It should be noted that a single query question may correspond to one or more query types. When a single query question corresponds to more than one query type, the query types may be at the same level or may have a hierarchical relationship, which is not limited herein.

After the query type is obtained, corresponding example pairs may be selected from the set of candidate example pairs according to the query type to form a set of target example pairs. For example, if the query type is “ranking list type”, all example pairs labeled with “ranking list type” may be selected from the set of candidate example pairs to form the set of target example pairs.

According to embodiments of the present disclosure, by classifying the query question based on the preset classification rule, a filtering scope of example pairs may be quickly narrowed, thereby reducing unnecessary computation and matching workload. Furthermore, the reference examples obtained from the set of target example pairs are highly relevant to the query question and may provide strong reference for the large model to generate query statements, thereby improving the quality of generated statements, reducing manual intervention, and enhancing the degree of intelligence in data query. In this way, an automated and intelligent classification of query questions may be achieved, and the matched reference examples may be accurately determined, thereby effectively improving the accuracy and efficiency in generating query statements.

In an embodiment, the query type includes an operation type and an object type. The operation type may include at least one of a data presentation type, a data statistics type, a data arrangement type, a comparative analysis type, or a trend analysis type. The object type includes at least one of a time type, a subject type, or an indicator type.

The data presentation type refers to an operation type that focuses on presenting data in an intuitive manner, such as presenting a detailed list or viewing specific details. For example, for the query “Please list the monthly sales records of the company in year X”, it is required to present the sales records of each month in a list form to facilitate viewing of the detailed data.

The data statistics type refers to an operation type involving statistical calculations of data, such as aggregate statistics including summation, counting, averaging, and so on. For example, for the query “Please calculate the total annual sales of the company in year X”, it is required to perform a summation of the sales across the months.

The data arrangement type refers to an operation type involving sorting-related operations on data, such as arranging data in ascending or descending order according to a specific indicator, retrieving top few items, or determining ranks. For example, for the query “Please sort the monthly sales of the company in year X in descending order”, it is required to perform an arrangement operation on the monthly sales.

The comparative analysis type refers to an operation type that focuses on comparison between different data, such as comparative analysis of data between different time periods or different departments, to identify differences and variations. For example, for the query “Please compare the differences in monthly sales between year X and year Y for the company”, it is required to perform a comparative analysis on the data from the two years.

The trend analysis type refers to an operation type involving analyzing the trend of data over time, such as time series analysis or growth rate calculation. For example, for the query “Please analyze the growth trend of monthly sales for the company in year X”, it is required to analyze the trend of sales changing over time.

The time type refers to an object attribute related to time, such as year, month, or quarter. For example, in the query “Please retrieve the profit data of each month in the first quarter of year X for the company”, the phrase “each month in the first quarter of year X” corresponds to the time type.

The subject type refers to a main target object of the query, such as a company, department, or employee. For example, in the query “Please calculate the sales of each department in year X”, the phrase “each department” corresponds to the subject type.

The indicator type refers to a quantitative indicator used to measure and describe the characteristics or performance of a subject, such as sales, profit, cost, or output. For example, in the query “Please identify the top five companies in terms of sales in year X”, the term “sales” corresponds to the indicator type.

According to embodiments of the present disclosure, through the detailed division of operation types and object types, a foundation is provided for accurately determining the query type. Such division covers various common data query operations and object attributes and may satisfy users' diverse and complex query requirements, thereby effectively improving the performance of data table question answering and user experience. Accordingly, it is possible to more accurately determine suitable example pairs matched with the query question, and enhance the accuracy in generating query statements.

In embodiments of the present disclosure, the set of candidate example pairs may include a plurality of subsets divided according to query types. The specific division method may be configured according to actual service requirements and is not limited herein. For example, the priority of operation types may be higher than that of object types. That is, the set of candidate example pairs may include a plurality of first subsets divided according to operation types, and each first subset may include a plurality of second subsets divided according to object types.

In an embodiment, determining a set of target example pairs from the set of candidate example pairs according to the query type may include the following operations: filtering the plurality of first subsets according to the operation type to obtain at least one target first subset; and for each target first subset, filtering the plurality of second subsets according to the object type to obtain the set of target example pairs.

The operation type refers to the type of operation related to the query question. The object type refers to the type of data related to the query question. By using a multi-level indexing structure of a data table and treating the operation type and the object type as two indexing levels, a set of candidate example pairs may be organized accordingly. When a query is to be performed, the corresponding example pairs may be quickly located according to the operation type and the object type, thereby obtaining a set of target example pairs.

The first subsets refers to subsets in the set of candidate example pairs that are divided according to the operation type. Each first subset may correspond to an operation type and may include a plurality of second subsets corresponding to different object types under that operation type. For example, example pairs of a statistical report type (operation type) may be divided into second subsets such as company statistical reports and department statistical reports according to the object type. After the query type is obtained, the corresponding first subset may be determined from the set of candidate example pairs according to the operation type in the query type, thereby obtaining the target first subset.

The second subsets refer to subsets in a first subset that are divided according to the object type. Each second subset corresponds to an object type and includes example pairs under the combination of the operation type and the object type. After the target first subset is obtained, the corresponding second subset may be determined from the target first subset according to the object type in the query type, thereby obtaining the set of target example pairs.

According to embodiments of the present disclosure, by subdividing the query type into the operation type and the object type and by organizing and filtering the set of candidate example pairs in a hierarchical manner, the management and retrieval of example pairs become more efficient, thereby reducing unnecessary search scope and lowering computational complexity. As a result, users' diverse and specific query requirements may be satisfied better, example pairs matching the query question may be determined more accurately, and the accuracy and efficiency in generating query statements may be improved.

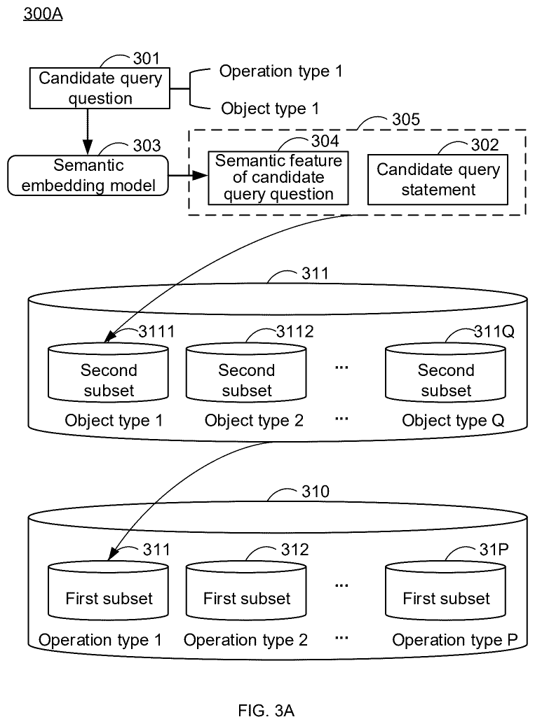

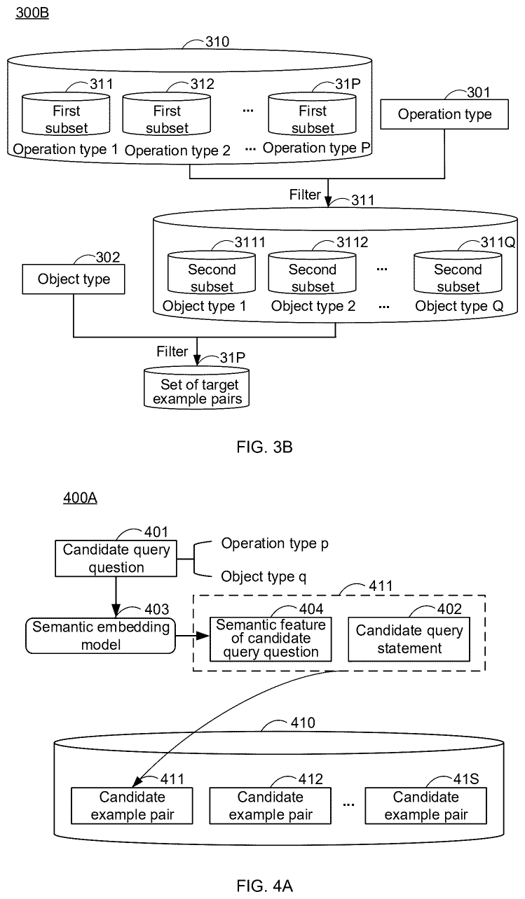

A process for constructing a set of candidate example pairs according to the present disclosure will be further described below with reference to FIG. 3A as an example.

FIG. 3A schematically shows a schematic diagram of an example process for constructing a set of candidate example pairs according to an embodiment of the present disclosure.

As shown in FIG. 3A, in 300A, an acquisition of a candidate query question 301, which belongs to operation type 1 and object type 1, is illustrated by way of example in describing the process for constructing a set of candidate example pairs.

While the candidate query question 301 is acquired, a candidate query statement 302 corresponding to the candidate query question 301 is also acquired. For the candidate query question 301, a semantic feature extraction may be performed on the candidate query question 301 using a semantic embedding model 303, to obtain a semantic feature 304 of candidate query question. The semantic feature 304 of candidate query question and the candidate query statement 302 together form a candidate example pair 305. Since the candidate query question 301 belongs to object type 1, the candidate example pair 305 may be stored in a second subset 3111 corresponding to object type 1.

Similarly, candidate example pairs belonging to object type 2 may be stored in a second subset 3112, . . . , and candidate example pairs belonging to object type Q may be stored in a second subset 311Q, where Q is a positive integer. On this basis, since the candidate query question 301 also belongs to operation type 1, the second subset 3111, the second subset 3112, . . . , and the second subset 311Q may form a first subset 311 corresponding to operation type 1.

Similarly, candidate example pairs belonging to operation type 2 may be stored in a first subset 312, . . . , and candidate example pairs belonging to operation type P may be stored in a first subset 31P, where P is a positive integer. On this basis, the first subset 311, the first subset 312, . . . , and the first subset 31P may form a set of candidate example pairs 310.

In embodiments of the present disclosure, when the set of candidate example pairs includes a plurality of first subsets divided according to the operation type and each first subset includes a plurality of second subsets divided according to the object type, a process for determining a set of target example pairs according to the present disclosure will be further described below with reference to FIG. 3B as an example.

FIG. 3B schematically shows a schematic diagram of an example process for constructing a set of target example pairs according to an embodiment of the present disclosure.

As shown in FIG. 3B, in 300B, a set of candidate example pairs 310 may include a first subset 311 corresponding to operation type 1, a first subset 312 corresponding to operation type 2, . . . , and a first subset 31P corresponding to operation type P. In this case, the plurality of first subsets may be filtered according to an operation type 301 to obtain a target first subset 311.

The target first subset 311 may include a second subset 3111 corresponding to object type 1, a second subset 3112 corresponding to object type 2, . . . , and a second subset 311Q corresponding to object type Q. In this case, the plurality of second subsets may be filtered according to an object type 302 to obtain a set of target example pairs 31P.

In embodiments of the present disclosure, the set of candidate example pairs may include a plurality of candidate example pairs that are not divided according to the query type. In an embodiment, the set of candidate example pairs may include a plurality of candidate example pairs, and each candidate example pair has a corresponding operation type and a corresponding object type. Determining a set of target example pairs from the set of candidate example pairs according to the query type may include the following operations: filtering the candidate example pairs in the set of candidate example pairs according to the operation type to obtain one or more intermediate example pairs; and filtering the one or more intermediate example pairs according to the object type to obtain the set of target example pairs.

The intermediate example pair refers to an example pair obtained after filtering the set of candidate example pairs according to the operation type. The intermediate example pair has an operation type consistent with that of the query question, but has not been filtered according to the object type. Therefore, the intermediate example pair serves as an intermediate result in the filtering process. The method for determining the intermediate example pair may be configured according to actual service requirements and is not limited herein.

For example, when the set of candidate example pairs is implemented in the form of a library, each candidate example pair may be labeled with the corresponding operation type and object type during the construction of the set of candidate example pairs. When a query question is received, all example pairs having the same or similar operation type may be selected from the set of candidate example pairs according to the operation type of the query question to obtain intermediate example pairs. Alternatively, when the set of candidate example pairs is implemented in the form of a hash table, the operation type may be used as the hash key when storing the set of candidate example pairs in the hash table. When filtering is performed, the operation type of the query question may be directly used as the key value to quickly locate corresponding example pairs in the hash table, thereby obtaining intermediate example pairs.

After intermediate example pairs are obtained, a secondary filtering may be performed on the intermediate example pairs according to the object type to obtain a set of target example pairs. Each candidate example pair in the set of target example pairs matches the query question in both the operation type and the object type. The method for determining the set of target example pairs may be configured according to actual service requirements and is not limited herein.

For example, on the basis of the intermediate example pairs, the set of target example pairs may be obtained by further filtering the intermediate example pairs according to the object type of the query question. Alternatively, an object-type index tree may be constructed by organizing the intermediate example pairs into a tree structure indexed according to their object types. When the object type of the query question is available, the index tree may be traversed from a root node, and the corresponding example-pair nodes are progressively located according to the object type, thereby obtaining the set of target example pairs.

According to embodiments of the present disclosure, the intermediate example pairs are obtained by filtering according to the operation type, and the set of target example pairs is then obtained by further filtering according to the object type. Such stepwise filtering method progressively reduces the scope of reference examples, and the finally obtained set of target example pairs is highly relevant to the query question in terms of both operation and object. As a result, a strong support is provided for subsequently generating accurate query statements using reference examples, interference from irrelevant examples may be reduced, and reference examples may be accurately selected for the query question, thereby improving the accuracy and efficiency in generating query statements.

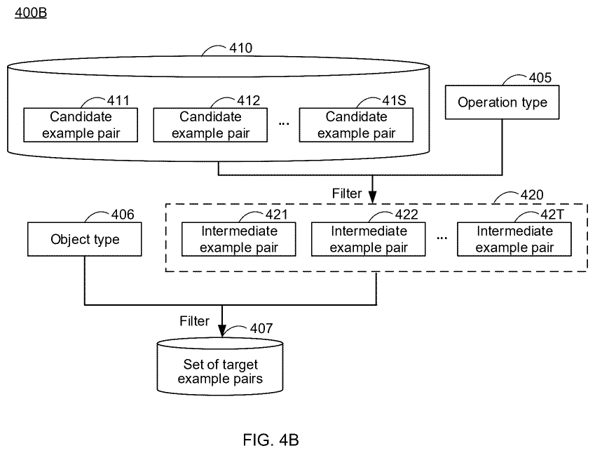

A process for constructing a set of candidate example pairs according to the present disclosure will be further described below with reference to FIG. 4A as an example.

FIG. 4A schematically shows a schematic diagram of an example process for determining a set of candidate example pairs according to another embodiment of the present disclosure.

As shown in FIG. 4A, an acquisition of a candidate query question 401, which belongs to operation type p and object type q, is illustrated by way of example in describing the process for constructing a set of candidate example pairs.

While the candidate query question 401 is acquired, a candidate query statement 402 corresponding to the candidate query question 401 is also acquired. For the candidate query question 401, a semantic feature extraction may be performed on the candidate query question 401 using a semantic embedding model 403, to obtain a semantic feature 404 of candidate query question. The semantic feature 404 of candidate query question and the candidate query statement 402 together form a candidate example pair 411. On this basis, the candidate example pair 411 may be stored in a set of candidate example pairs 410. The set of candidate example pairs 410 may further include a candidate example pair 412, . . . , and a candidate example pair S, where S is a positive integer.

In embodiments of the present disclosure, when the set of candidate example pairs includes a plurality of candidate example pairs that are not divided according to the query type, a process for determining a set of target example pairs according to the present disclosure will be further described below with reference to FIG. 4B as an example.

FIG. 4B schematically shows a schematic diagram of an example process for determining a set of target example pairs according to another embodiment of the present disclosure.

As shown in FIG. 4B, in 400B, a set of candidate example pairs 410 may include a candidate example pair 1, a candidate example pair 2, . . . , and a candidate example pair 41S of different operation types. In this case, the plurality of candidate example pairs may be filtered according to an operation type 405 to obtain one or more intermediate example pairs 420. For example, an intermediate example pair 421, an intermediate example pair 422, . . . , and an intermediate example pair 42T may be obtained, where T is a positive integer less than or equal to S. On this basis, the one or more intermediate example pairs 420 may be filtered according to an object type 406 to obtain a set of target example pairs 407.

In an embodiment, a reference example pair includes a reference query question and a reference query statement. Matching the query question against the set of target example pairs to obtain at least one reference example pair may include the following operations: determining a similarity between the semantic feature of the query question and the semantic feature of each reference query question, thereby obtaining a plurality of similarities; and determining candidate example pairs corresponding to top N similarities among the sorted plurality of similarities as the reference example pairs, where N is a positive integer.

The semantic feature refers to an abstract representation of the core meaning and key information expressed by a natural language text, which may reflect the semantic content and focus of the text. For example, a natural language text may be converted into a high-dimensional vector by a semantic embedding model to capture its semantic features. After obtaining the semantic feature of the query question, the similarities between the semantic feature of the query question and the semantic features of the reference query questions may be determined. The similarity is used to measure a degree of similarity between the semantic feature of the query question and the semantic feature of the reference query question, and may be expressed in the form of a numerical value, where a larger numerical value indicates a higher degree of similarity.

For example, the query question and each reference query question may be converted into respective high-dimensional vector representations by using a semantic embedding model, and then a similarity between the two vectors may be calculated. In an example, the similarity may be determined according to Equation (1).

$$sim ( q , a ) = cosine ( {v}_{q} , {v}_{a} ) = \frac{{v}_{q} \cdot {v}_{a}}{‖ {v}_{q} ‖ \times ‖ {v}_{a} ‖} \qquad ( 1 )$$

where q represents a query question, a represents a reference query question, sim(q, a) represents a similarity between the query question and the reference query question, v_{q} represents a semantic feature of the query question, vₐ represents a semantic feature of the reference query question, and cosine(v_{q}, vₐ) represents a cosine similarity.

Alternatively, a method combining keyword matching and semantic analysis may be adopted. For example, a word segmentation may be performed on the query question and the reference query question to extract keywords. Then, a matching degree between the keywords may be calculated, while a semantic similarity between the keywords may be calculated using a word vector model. The final similarity may then be obtained by combining the keyword matching degree and the semantic similarity.

After a plurality of similarities are obtained, these similarities may be sorted to obtain sorted plurality of similarities. On this basis, the candidate example pairs corresponding to top N similarities among the sorted plurality of similarities, that is, N candidate example pairs having the highest similarities, may be selected as reference example pairs. For example, if the sorted similarity values are 0.9, 0.85, 0.8, 0.75 . . . , then when N is set to 3, the three candidate example pairs corresponding to the similarities of 0.9, 0.85, and 0.8 are selected as reference example pairs.

Alternatively, a clustering analysis-based method may be adopted to perform clustering analysis on the calculated similarities to determine clusters having higher similarities, and then a certain number of candidate example pairs are selected from each cluster as reference example pairs. For example, after clustering the similarity values, two clusters may be obtained, one cluster has high similarity values (e.g., 0.85 and above), and the other cluster has low similarity values (e.g., 0.7 and below). Top N candidate example pairs in the high-similarity cluster may then be selected as reference example pairs.

According to embodiments of the present disclosure, by analyzing the semantic features of the reference example pairs and calculating the similarities, it is possible to accurately select, from the plurality of candidate example pairs, the reference example pairs that are most relevant to the query question. This improves the accuracy and efficiency of natural language-based data query systems, enables more accurate understanding of users' query intent, and help generate query statements that better satisfy users' requirements, thereby improving user experience and performance of data query, and providing more precise and efficient data query services for users.

In an embodiment, the plurality of similarities include n1 similarities for each query type. Determining candidate example pairs corresponding to top N similarities among the sorted plurality of similarities as the reference example pairs may include the following operations: for each query type, determining candidate example pairs corresponding to top n2 similarities among sorted n1 similarities as reference example pairs for that query type, such that a repetition degree of that query type covered by the reference example pairs is less than a preset repetition threshold, where n2 is less than or equal to n1, and n1 is less than N.

For each query type, the similarity between the query question and the reference query question in each candidate example pair under that query type may be calculated using a semantic-similarity calculation method, thereby obtaining n1 similarities. Alternatively, a machine learning-based similarity prediction model may be adopted. A model may be trained to predict the similarity between the query question and the reference query question. For each query type, the query question and the reference query questions under that query type may be input to the model to obtain n1 predicted similarity values. Here, n1 refers to the number of similarities set for each query type, that is, the number of similarity values calculated under each query type.

The preset repetition threshold is a parameter predetermined to control the repetition degree of each query type covered by the reference example pairs so as to ensure diversity of the reference example pairs. Here, n2 refers to the number of reference example pairs to be selected. That is, for each query type, the top n2 similarities are selected from the sorted similarities to determine the reference example pairs, where n2 is less than or equal to n1.

The n1 similarities for each query type may be sorted, and the candidate example pairs corresponding to the top n2 similarities may be selected as the reference example pairs for that query type. By controlling the value of n2, it may be ensured that the repetition degree of each query type covered by the reference example pairs remains below the preset repetition threshold. Alternatively, clustering analysis may be introduced so that candidate example pairs corresponding to n1 similarities for each query type may be clustered, and n2 example pairs proximate to a cluster center may be selected as the reference example pairs while monitoring the repetition degree to remain below the preset repetition threshold.

According to embodiments of the present disclosure, by selecting, for each query type, the candidate example pairs corresponding to the top n2 similarities as the reference example pairs and by controlling the repetition degree, it is possible to ensure a balanced coverage across different query types on the basis of ensuring that the reference example pairs are highly relevant to the query question, so that various types of query questions may be more comprehensively handled, and the diversity and representativeness of the reference example pairs may be effectively improved, thereby avoiding excessive reliance on example pairs from specific query types, and enhancing the accuracy and adaptability in generating query statements.

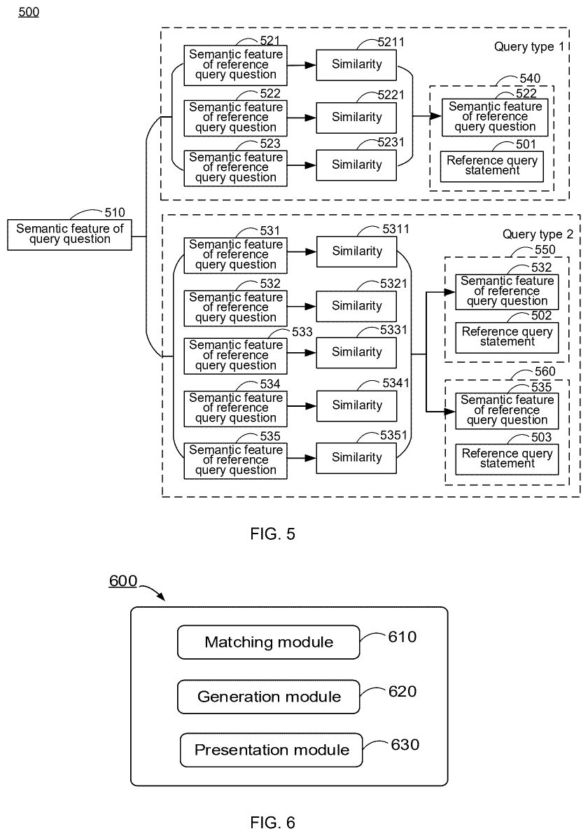

A process for determining reference example pairs will be further described below with reference to FIG. 5.

FIG. 5 schematically shows a schematic diagram of an example process for determining a reference example pair according to an embodiment of the present disclosure.

As shown in FIG. 5, in 500, the process for determining reference example pairs is illustrated using an example in which the query type of the query question includes query type 1 and query type 2.

Query type 1 may correspond to three reference query questions, and the semantic features of the three reference query questions are respectively referred to as a semantic feature 521 of reference query question, a semantic feature 522 of reference query question, and a semantic feature 523 of reference query question.

For the above semantic features, similarities between a semantic feature 510 of query question and these semantic features may be respectively determined. For example, a similarity 5211 between the semantic feature 510 of query question and the semantic feature 521 of reference query question, a similarity 5221 between the semantic feature 510 of query question and the semantic feature 522 of reference query question, and a similarity 5231 between the semantic feature 510 of query question and the semantic feature 523 of reference query question may be determined.

After the similarities are obtained, these similarities may be sorted to obtain sorted plurality of similarities. For example, if the similarity 5221 is the highest among the similarity 5211, the similarity 5221, and the similarity 5231, then the semantic feature 522 of reference query question and a corresponding reference query statement 501 may be determined as a reference example pair 540 for query type 1.

Query type 2 may correspond to five reference query questions, and the semantic features of the five reference query questions are respectively referred to as a semantic feature 531 of reference query question, a semantic feature 532 of reference query question, a semantic feature 533 of reference query question, a semantic feature 534 of reference query question, and a semantic feature 535 of reference query question.

For the above semantic features, similarities between the semantic feature 510 of query question and these semantic features may be respectively determined. For example, a similarity 5311 between the semantic feature 510 of query question and the semantic feature 531 of reference query question, a similarity 5321 between the semantic feature 510 of query question and the semantic feature 532 of reference query question, a similarity 5331 between the semantic feature 510 of query question and the semantic feature 533 of reference query question, a similarity 5341 between the semantic feature 510 of query question and the semantic feature 534 of reference query question, and a similarity 5351 between the semantic feature 510 of query question and the semantic feature 535 of reference query question may be determined.

After the similarities are obtained, these similarities may be sorted to obtain sorted similarities. For example, if the similarity 5321 and the similarity 5351 rank in the top two among the similarity 5311, the similarity 5321, the similarity 5331, the similarity 5341, and the similarity 5351, then the semantic feature 532 of reference query question and a corresponding reference query statement 502 may be determined as a reference example pair 550 for query type 2, and the semantic feature 535 of reference query question and a corresponding reference query statement 503 may be determined as a reference example pair 560 for query type 2.

In an embodiment, after the set of candidate example pairs is constructed, the following operations may further be performed: determining a contribution degree of each candidate example pair in the set of candidate example pairs according to at least one of a usage frequency of the candidate example pair and an accuracy rate of a historical query statement generated using the candidate example pair; and updating the set of candidate example pairs according to the contribution degree and a preset contribution threshold.

The usage frequency refers to the number of times each candidate example pair has been selected and used to generate query statements within a preset historical time period. The accuracy rate refers to a proportion of query statements that are correct and meet user requirements among the historical query statements generated using the candidate example pair.

The preset time period may be configured according to actual service requirements and is not limited herein. For example, the preset time period may be determined according to at least one of a data volume or a data update frequency in the application scenario of the information presentation method. For example, if application scenario A corresponds to a larger data volume, the time period may be set shorter, whereas for application scenario B that corresponds to a smaller data volume, the time period may be set longer. Similarly, if application scenario A corresponds to a higher data update frequency, the time period may be set shorter, whereas for application scenario B that corresponds to a lower data update frequency, the time period may be set longer.

After periodically collecting at least one of the usage frequency and the accuracy rate of each candidate example pair, a contribution degree may be obtained by comprehensively considering the usage frequency and the accuracy rate of the candidate example pair. The contribution degree may be used to measure the value and importance of the candidate example pair in the process of generating query statements. The method for obtaining the contribution degree may be configured according to actual service requirements and is not limited herein.

In an example, a weighted formula may be pre-designed such that the usage frequency and the accuracy rate are multiplied by their respective weight coefficients and then the results are summed to obtain the contribution degree of each candidate example pair. For example, the weighted formula may be defined as: ContributionDegree=Usage Frequency×0.6+Accuracy Rate×0.4. If a candidate example pair has been used 100 times and has an accuracy rate of 0.9, then its contribution degree may be calculated as 100×0.6+0.9×0.4=60+0.36=60.36.

In another example, a regression model in machine learning may be adopted, with the usage frequency and the accuracy rate as features and the contribution degree as a target variable, to train a model for predicting the contribution degree of each candidate example pair. For example, historical data including the usage frequency, accuracy rate, and manually annotated contribution degree of candidate example pairs may be collected. A model may then be trained using algorithms such as linear regression or decision tree regression, and the trained model may be used to predict the contribution degree of new candidate example pairs.

After the contribution degree of each candidate example pair is obtained, the set of candidate example pairs may be updated according to the contribution degree and the preset contribution threshold. For example, a candidate example pair whose contribution degree is lower than the preset contribution threshold may be removed from the set of candidate example pairs. Alternatively, a candidate example pair whose contribution degree is higher than the preset contribution threshold may be retained in the set of candidate example pairs.

According to embodiments of the present disclosure, by determining a contribution degree of a candidate example pair based on both the usage frequency and accuracy rate of the candidate example pair, and updating the set of candidate example pairs according to the contribution degree and the preset threshold, the system may automatically select high-quality and high-value example pairs while eliminating low-quality example pairs, which helps continuously optimize the set of candidate example pairs, thereby improving the accuracy and efficiency in generating query statements, ensuring better adaptation to user requirements and data variation, and enhancing both user experience and the intelligence level of the system.

In an embodiment, the query question may be directed to a data table, and the reference example pair includes a reference query question and a reference query statement. Operation S220 may include: concatenating the at least one reference example pair, the query question, and a description information of the data table corresponding to the query question, based on a preset prompt template, to obtain a prompt information, where the data table corresponding to the query question is obtained by performing semantic matching between the query question and description information of candidate data tables; invoking the large model according to the prompt information to generate an intermediate query statement; and determining the intermediate query statement as a target query statement in response to execution logic of the intermediate query statement satisfying a consistency condition with respect to execution logic of the reference query statement.

The description information refers to information describing the content, structure, fields, etc. of the data table. The preset prompt template refers to a pre-designed format and structure for constructing a prompt information, which specifies how to combine the reference example pair, the query question, and the description information of the data table into a prompt information. The method for constructing the prompt information may be configured according to actual service requirements and is not limited herein.

In an example, the preset prompt template may be “Reference query question: {ref_question}, reference query statement: {ref_query}. The current query question is: {question}, and the description information of the corresponding data table is: {table_desc}”. Specific contents may be filled into the preset prompt template to obtain the prompt information. In another example, a method combining template filling and natural language generation may be adopted. For example, according to a logical structure of the preset prompt template, it is possible to organize the reference example pair, the query question, and the description information of the data table into a smooth and natural prompt text by using natural language generation technology.

After the prompt information is obtained, the large model may be guided by the prompt information to generate an initial intermediate query statement. After the intermediate query statement is obtained, a determination may be performed as to whether the execution logic of the intermediate query statement satisfies a consistency condition with respect to the execution logic of each reference query statement. The specific content of the consistency condition and the specific determination method may be configured according to actual service requirements and is not limited herein.

In an example, the consistency condition may include: similar syntactic structure, the same operation type, similar fields and tables involved, etc. In another example, syntactic and semantic analysis may be performed on the intermediate query statement and each reference query statement to compare whether their execution logics meet the consistency condition. Alternatively, a graph model-based comparison method may be adopted, in which the execution logic of the intermediate query statement and the execution logic of each reference query statement may be transformed into graph structures such as abstract syntax trees, and then the similarities of these graph structures may be compared to determine whether the consistency condition is satisfied according to the similarity.

According to embodiments of the present disclosure, by combining the query question with the reference example pair and the description information of the data table, generating prompt information using the preset prompt template, then invoking the large model to generate an intermediate query statement, and finally determining the target query statement through the verification of the consistency condition, the accuracy and reliability in generating query statements may be improved, the error rate may be reduced, and the user experience may be enhanced. Furthermore, the reference example pairs and the data table information may be fully utilized to improve the capability of understanding and processing complex query questions.

The above are merely exemplary embodiments, and the present disclosure is not limited thereto. Other information presentation methods based on a large model in the art may also be included, as long as the most relevant examples may be selected automatically and intelligently for each query question to improve the accuracy and efficiency in generating query statements and acquiring query results.

Based on the above-described information presentation method based on a large model, the present disclosure further provides an information presentation apparatus based on a large model. The apparatus will now be described in detail with reference to FIG. 6.

FIG. 6 schematically shows a block diagram of an information presentation apparatus based on a large model according to an embodiment of the present disclosure.

As shown in FIG. 6, an information presentation apparatus 600 based on a large model may include a matching module 610, a generation module 620, and a presentation module 630.

The matching module 610 is used to match, in response to receiving a query question, the query question against a set of target example pairs corresponding to a query type of the query question to obtain at least one reference example pair, where the reference example pair is used to guide the large model to generate a query statement for the query question.

The generation module 620 is used to invoke the large model according to a prompt information, which is obtained based on the query question and the at least one reference example pair, to generate a target query statement.

The presentation module 630 is used to present a query result obtained by executing the target query statement.

According to embodiments of the present disclosure, the matching module 610 may include a classification sub-module, a determination sub-module, and a matching sub-module.

The classification sub-module is used to classify the query question according to a preset classification rule to obtain the query type, where the preset classification rule defines at least one of a keyword corresponding to the query type, semantics corresponding to the query type, or an expression form corresponding to the query type.

The first determination sub-module is used to determine the set of target example pairs from a set of candidate example pairs according to the query type.

The matching sub-module is used to match the query question against the set of target example pairs to obtain the at least one reference example pair.

According to embodiments of the present disclosure, the query type includes an operation type and an object type, the set of candidate example pairs includes a plurality of first subsets respectively corresponding to a plurality of operation types, and each first subset includes a plurality of second subsets respectively corresponding to a plurality of object types.

According to embodiments of the present disclosure, the first determination sub-module may include a first filtering unit and a second filtering unit.

The first filtering unit is used to filter the plurality of first subsets according to the operation type to obtain at least one target first subset.

The second filtering unit is used to, for each target first subset, filter the plurality of second subsets according to the object type to obtain the set of target example pairs.

According to embodiments of the present disclosure, the query type includes an object type and an operation type, the set of candidate example pairs includes a plurality of candidate example pairs, and each candidate example pair has a corresponding operation type and a corresponding object type.

According to embodiments of the present disclosure, the first determination sub-module may include a third filtering unit and a fourth filtering unit.

The third filtering unit is used to filter the candidate example pairs in the set of candidate example pairs according to the operation type to obtain one or more intermediate example pairs.

The fourth filtering unit is used to filter the one or more intermediate example pairs according to the object type to obtain the set of target example pairs.

According to embodiments of the present disclosure, the reference example pair includes a reference query question and a reference query statement.

According to embodiments of the present disclosure, the matching sub-module may include a first determination unit and a second determination unit.

The first determination unit is used to determine a similarity between a semantic feature of the query question and a semantic feature of each reference query question, thereby obtaining a plurality of similarities.

The second determination unit is used to determine candidate example pairs corresponding to top N similarities among the sorted plurality of similarities as the reference example pairs, where N is a positive integer.

According to embodiments of the present disclosure, the plurality of similarities include n1 similarities for each query type.

According to embodiments of the present disclosure, the second determination unit may include a determination sub-unit.

The determination sub-unit is used to, for each query type, determine candidate example pairs corresponding to top n2 similarities among the sorted n1 similarities as the reference example pairs for that query type, such that a repetition degree of that query type covered by the reference example pairs is less than a preset repetition threshold, where n2 is less than or equal to n1, and n1 is less than N.

According to embodiments of the present disclosure, the apparatus 600 for information present based on a large model may further include a determination module and an update module.

The determination module is used to determine a contribution degree of each candidate example pair in the set of candidate example pairs according to at least one of a usage frequency of the candidate example pair and an accuracy rate of historical query statements generated using the candidate example pair.

The update module is used to update the set of candidate example pairs according to the contribution degree and a preset contribution threshold.

According to embodiments of the present disclosure, the query question is directed to a data table, and the reference example pair includes a reference query question and a reference query statement.

According to embodiments of the present disclosure, the generation module 620 may include a concatenation sub-module, a generation sub-module, and a second determination sub-module.

The concatenation sub-module is used to concatenate the at least one reference example pair, the query question, and a description information of a data table corresponding to the query question, based on a preset prompt template, to obtain the prompt information, where the data table corresponding to the query question is obtained by performing semantic matching between the query question and description information of candidate data tables.

The generation sub-module is used to invoke the large model according to the prompt information to generate an intermediate query statement.

The second determination sub-module is used to determine the intermediate query statement as the target query statement in response to execution logic of the intermediate query statement satisfying a consistency condition with respect to execution logic of each reference query statement.

According to embodiments of the present disclosure, the operation type includes at least one of a data presentation type, a data statistics type, a data arrangement type, a comparative analysis type, or a trend analysis type; and the object type includes at least one of a time type, a subject type, or an indicator type.

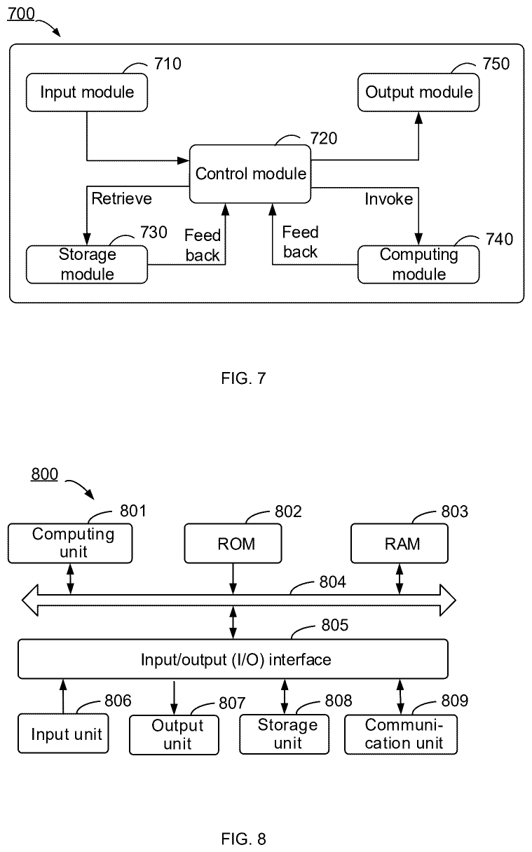

FIG. 7 schematically shows a structural block diagram of an agent of a large model according to an embodiment of the present disclosure.

In an embodiment of the present disclosure, inspired by the von Neumann architecture in modern computer theory, as shown in FIG. 7, an AI agent 700 may include five core modules: an input module 710, a control module 720, a storage module 730, a computing module 740, and an output module 750.

The input module 710 is responsible for receiving or perceiving information such as queries, requests, instructions, signals, or data from the outside (such as users or the external environment) and converting them into a format that the AI agent 700 may understand and process. The input module 710 is a primary link for the AI agent 700 to interact with the outside world, enabling the AI agent 700 to efficiently and accurately obtain necessary “sensory” information from the outside world and make a response to the information.

In an example, the input module 710 may input the query question described above.

The control module 720 is the core support for the AI agent 700 to handle complex tasks. In the model training phase, the control module 720 may perform the above-described information presentation method based on a large model.

In an example, the control module 720 may continuously interact with the storage module 730, the computing module 740, and/or the output module 750 during operation. However, it should be noted that in embodiments of the present disclosure, the control module 720 initiates communication with the storage module 730, the computing module 740, and/or the output module 750 as a single initiator, and there is no communication coupling between the storage module 730, the computing module 740, and the output module 750.

In an example, the performance of the control module 720 is closely related to the large model on which the AI agent 700 is based. In order to give full play to the capabilities of the large model, the internal structure of the control module 720 may be designed to be highly configurable and extensible, so as to meet various types of tasks and requirements in real scenarios.

The storage module 730 may be responsible for memorizing the set of candidate example pairs. The above-described set of candidate example pairs may be included in the storage module 730.

In an example, after receiving the query question, the AI agent 700 may trigger an information generation process based on a large model, acquire the set of candidate example pairs from the storage module 730, and return the same to the control module 720. Then, the control module 720 may transmit the returned query result to the output module 750.

The computing module 740 may be regarded as a predefined tool library. Tools for determining semantic features and tools for calculating similarities as described above may be included in the computing module 740.

In an example, when the AI agent 700 needs to process a query question, relevant tools may be invoked from the computing module 740 and fed back to the control module 720. Then, the control module 720 may use the fed-back tools to process the query question to obtain the query result. It may be understood that although the large model has excellent language understanding and generation capabilities, like humans, its capability to perform tasks are limited if without any tools. Once the AI agent 700 is endowed with the ability to invoke tools, it may accomplish tasks such as determining semantic features with the help of tools for determining semantic features and calculating similarities with the help of tools for calculating similarities.

In the model training phase, the output module 750 may output the above-mentioned query result.

The AI agent 700 according to embodiments of the present disclosure may simply and effectively improve the degree of intelligence, and enhance flexibility and versatility.

FIG. 8 schematically shows a block diagram of an electronic device suitable for implementing the information presentation method based on a large model according to an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 includes a computing unit 801 which may perform various appropriate actions and processes according to a computer program stored in a read only memory (ROM) 802 or a computer program loaded from a storage unit 8012 into a random access memory (RAM) 803. In the RAM 803, various programs and data necessary for an operation of the electronic device 800 may also be stored. The computing unit 801, the ROM 802 and the RAM 803 are connected to each other through a bus 804. An input/output (I/O) interface 805 is also connected to the bus 804.

A plurality of components in the electronic device 800 are connected to the I/O interface 805, including: an input unit 806, such as a keyboard, or a mouse; an output unit 807, such as presents or speakers of various types; a storage unit 808, such as a disk, or an optical disc; and a communication unit 809, such as a network card, a modem, or a wireless communication transceiver. The communication unit 809 allows the electronic device 800 to exchange information/data with other devices through a computer network such as Internet and/or various telecommunication networks.

The computing unit 801 may be various general-purpose and/or dedicated processing assemblies having processing and computing capabilities. Some examples of the computing units 801 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 801 executes various methods and processes described above, such as the information presentation method based on a large model. For example, in some embodiments, the information presentation method based on a large model may be implemented as a computer software program which is tangibly embodied in a machine-readable medium, such as the storage unit 808. In some embodiments, the computer program may be partially or entirely loaded and/or installed in the electronic device 800 via the ROM 802 and/or the communication unit 809. The computer program, when loaded in the RAM 803 and executed by the computing unit 801, may execute one or more steps in the information presentation method based on a large model described above. Alternatively, in other embodiments, the computing unit 801 may be used to perform the information presentation method based on a large model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the information presentation method based on a large model of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a present device (for example, a CRT (cathode ray tube) or LCD (liquid crystal present) monitor) for presenting information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. An information presentation method based on a large model, the method comprising:
matching, in response to receiving a query question, the query question against a set of target example pairs corresponding to a query type of the query question to obtain at least one reference example pair, wherein the large model is configured to generate a query statement for the query question using the reference example pair;
invoking the large model according to a prompt information to generate a target query statement, wherein the prompt information is obtained based on the query question and the at least one reference example pair; and
presenting a query result obtained by executing the target query statement.

2. The method of claim 1, wherein the matching the query question against the set of target example pairs corresponding to the query type of the query question to obtain at least one reference example pair comprises:
classifying the query question according to a preset classification rule to obtain the query type of the query question, wherein the preset classification rule defines at least one of a keyword corresponding to the query type, semantics corresponding to the query type, or an expression form corresponding to the query type;
determining, from a set of candidate example pairs, the set of target example pairs according to the query type; and
matching the query question against the set of target example pairs to obtain the at least one reference example pair.

3. The method of claim 2, wherein the query type comprises an operation type and an object type, the set of candidate example pairs comprises a plurality of first subsets respectively corresponding to a plurality of operation types, and each of the plurality of first subsets comprises a plurality of second subsets respectively corresponding to a plurality of object types; and
wherein the determining, from the set of candidate example pairs, the set of target example pairs according to the query type comprises:
determining at least one target first subset from the plurality of first subsets according to the operation type; and
determining, for each of the at least one target first subset, the set of target example pairs from the plurality of second subsets according to the object type.

4. The method of claim 2, wherein the query type comprises an object type and an operation type, the set of candidate example pairs comprises a plurality of candidate example pairs, and each of the plurality of candidate example pairs has a corresponding operation type and a corresponding object type; and
wherein the determining, from the set of candidate example pairs, the set of target example pairs according to the query type comprises:
determining one or more intermediate example pairs from the plurality of candidate example pairs in the set of candidate example pairs according to the operation type; and
determining the set of target example pairs from the one or more intermediate example pairs according to the object type.

5. The method of claim 2, wherein the reference example pair comprises a reference query question and a reference query statement; and
wherein the matching the query question against the set of target example pairs to obtain the at least one reference example pair comprises:
determining a similarity between a semantic feature of the query question and a semantic feature of each reference query question, so as to obtain a plurality of similarities; and
determining candidate example pairs corresponding to top N similarities among the sorted plurality of similarities as the reference example pairs, where N is a positive integer.

6. The method of claim 5, wherein the plurality of similarities comprise n1 similarities for each query type; and
wherein the determining candidate example pairs corresponding to top N similarities among the sorted plurality of similarities as the reference example pairs comprises:
determining, for each query type, candidate example pairs corresponding to top n2 similarities among the sorted n1 similarities as reference example pairs for the query type, so that a repetition degree of the query type covered by the reference example pairs is less than a preset repetition threshold, where n2 is less than or equal to n1, and n1 is less than N.

7. The method of claim 2, further comprising:
determining a contribution degree of each candidate example pair in the set of candidate example pairs according to at least one of a usage frequency of each candidate example pair or an accuracy rate of a historical query statement generated using each candidate example pair; and
updating the set of candidate example pairs according to the contribution degree and a preset contribution threshold.

8. The method of claim 1, wherein the query question is directed to a data table, and the reference example pair comprises a reference query question and a reference query statement; and
wherein the invoking the large model according to the prompt information obtained based on the query question and the at least one reference example pair to generate the target query statement comprises:
concatenating, based on a preset prompt template, the at least one reference example pair, the query question, and a description information of a data table corresponding to the query question to obtain the prompt information, wherein the data table corresponding to the query question is obtained by performing semantic matching between the query question and description information of candidate data tables;
invoking the large model according to the prompt information to generate an intermediate query statement; and
determining the intermediate query statement as the target query statement in response to execution logic of the intermediate query statement satisfying a consistency condition with respect to execution logic of the reference query statement.

9. The method of claim 3, wherein the operation type comprises at least one of: a data presentation type, a data statistics type, a data arrangement type, a comparative analysis type, or a trend analysis type; and the object type comprises at least one of a time type, a subject type, or an indicator type.

10. An artificial intelligence agent, configured to at least:
match, in response to receiving a query question, the query question against a set of target example pairs corresponding to a query type of the query question to obtain at least one reference example pair, wherein the large model is configured to generate a query statement for the query question using the reference example pair;
invoke the large model according to a prompt information to generate a target query statement, wherein the prompt information is obtained based on the query question and the at least one reference example pair; and
present a query result obtained by executing the target query statement.

11. An electronic device, comprising:
one or more processors; and
a memory configured to store one or more computer programs, wherein the one or more processors are configured to execute the one or more computer programs to at least:
match, in response to receiving a query question, the query question against a set of target example pairs corresponding to a query type of the query question to obtain at least one reference example pair, wherein the large model is configured to generate a query statement for the query question using the reference example pair;
invoke the large model according to a prompt information to generate a target query statement, wherein the prompt information is obtained based on the query question and the at least one reference example pair; and
present a query result obtained by executing the target query statement.

12. The electronic device of claim 11, wherein the one or more processors are further configured to execute the one or more computer programs to at least:
classify the query question according to a preset classification rule to obtain the query type of the query question, wherein the preset classification rule defines at least one of a keyword corresponding to the query type, semantics corresponding to the query type, or an expression form corresponding to the query type;
determine, from a set of candidate example pairs, the set of target example pairs according to the query type; and
match the query question against the set of target example pairs to obtain the at least one reference example pair.

13. The electronic device of claim 12, wherein the query type comprises an operation type and an object type, the set of candidate example pairs comprises a plurality of first subsets respectively corresponding to a plurality of operation types, and each of the plurality of first subsets comprises a plurality of second subsets respectively corresponding to a plurality of object types; and
wherein the one or more processors are further configured to execute the one or more computer programs to at least:
determine at least one target first subset from the plurality of first subsets according to the operation type; and
determine, for each of the at least one target first subset, the set of target example pairs from the plurality of second subsets according to the object type.

14. The electronic device of claim 12, wherein the query type comprises an object type and an operation type, the set of candidate example pairs comprises a plurality of candidate example pairs, and each of the plurality of candidate example pairs has a corresponding operation type and a corresponding object type; and
wherein the one or more processors are further configured to execute the one or more computer programs to at least:
determine one or more intermediate example pairs from the plurality of candidate example pairs in the set of candidate example pairs according to the operation type; and
determine the set of target example pairs from the one or more intermediate example pairs according to the object type.

15. The electronic device of claim 12, wherein the reference example pair comprises a reference query question and a reference query statement; and
wherein the one or more processors are further configured to execute the one or more computer programs to at least:
determine a similarity between a semantic feature of the query question and a semantic feature of each reference query question, so as to obtain a plurality of similarities; and
determine candidate example pairs corresponding to top N similarities among the sorted plurality of similarities as the reference example pairs, where N is a positive integer.

16. The electronic device of claim 15, wherein the plurality of similarities comprise n1 similarities for each query type; and
wherein the one or more processors are further configured to execute the one or more computer programs to at least:
determine, for each query type, candidate example pairs corresponding to top n2 similarities among the sorted n1 similarities as reference example pairs for the query type, so that a repetition degree of the query type covered by the reference example pairs is less than a preset repetition threshold, where n2 is less than or equal to n1, and n1 is less than N.

17. The electronic device of claim 12, wherein the one or more processors are further configured to execute the one or more computer programs to at least:
determine a contribution degree of each candidate example pair in the set of candidate example pairs according to at least one of a usage frequency of each candidate example pair or an accuracy rate of a historical query statement generated using each candidate example pair; and
update the set of candidate example pairs according to the contribution degree and a preset contribution threshold.

18. The electronic device of claim 11, wherein the query question is directed to a data table, and the reference example pair comprises a reference query question and a reference query statement; and
wherein the one or more processors are further configured to execute the one or more computer programs to at least:
concatenate, based on a preset prompt template, the at least one reference example pair, the query question, and a description information of a data table corresponding to the query question to obtain the prompt information, wherein the data table corresponding to the query question is obtained by performing semantic matching between the query question and description information of candidate data tables;
invoke the large model according to the prompt information to generate an intermediate query statement; and
determine the intermediate query statement as the target query statement in response to execution logic of the intermediate query statement satisfying a consistency condition with respect to execution logic of the reference query statement.

19. The electronic device of claim 13, wherein the operation type comprises at least one of: a data presentation type, a data statistics type, a data arrangement type, a comparative analysis type, or a trend analysis type; and the object type comprises at least one of a time type, a subject type, or an indicator type.

20. A non-transitory computer-readable storage medium having computer programs or instructions therein, wherein the computer programs or instructions, when executed by a processor, are configured to implement the method of claim 1.
